(19) United States
(12) Patent Application Publication
(10) Pub. No.: US 2002/0194265 A1
(43) Pub. Date: Dec. 19, 2002

(54) Marketing system for contacting a web site using a pre-recorded medium

(75) Inventors: Daniel Zipser, Westlake Village, CA (US); Erik Surwill, Culver City, CA (US); Peter Orr, Malibu, CA (US); Michael Maclean, Northridge, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: SMC/CRM Systems, Inc.

(21) Appl. No.: 09/880,275

(22) Filed: Jun. 13, 2001

(51) Int. Cl. G06F 15/16; G06F 17/60

(52) U.S. Cl. 709/203; 705/14; 709/218

(57) ABSTRACT

A combination marketing system for use in the retail or wholesale sale of goods and services is disclosed. The marketing system preferably includes the distribution of a pre-recorded medium which contains a presentation feature, a data collection feature, a data transmission feature, and a link feature. By using the marketing system, the seller is able to direct the customer to the seller's web site without the need for the customer to engage in any volitional acts to move from the conclusion of the presentation on the pre-recorded medium to the seller's web site, thereby avoiding the loss of the customer's attention and the possibility of the customer's error in entering the seller's web site address.

### FIELD OF THE INVENTION

The present invention relates generally to a marketing system for the retail and wholesale sale of goods or services and particularly to a marketing system that facilitates sales of goods and services by combining a sales presentation on a computer readable, pre-recorded medium with a direct and automatic link to a seller's Internet web site.

### BACKGROUND OF THE INVENTION

There are many types of advertising media available to retail and wholesale sellers of goods and services (hereinafter, collectively, “sellers”), e.g. print advertisements, informational kiosks, billboards, banners, radio and television advertisements, direct mailings, promotional videotapes, and Internet web sites. Existing advertising methods require viewers to engage in a volitional act to move from one advertising medium to another. For example, viewers of print advertisements or promotional videotapes must pick up their telephones and dial the telephone number provided by the first medium in order to speak with a representative of the seller.

Many print advertisements and radio/television advertisements promote visits to a seller's web site by including a statement such as, “Visit our web site at www.seller.com”. Unlike radio and television advertisements, an Internet web site is generally accessible to Internet users at any time. However, typically, visitors must know the address of the web site they wish to visit. Moreover, even if visitors know the Internet address they wish to visit, they may make a mistake in entering the address on their computer keyboard. Accordingly, to ensure that the visitor reaches the web site being promoted by the first advertising medium, it is desirable to include a direct link from a first advertising medium to a seller's web site.

Existing advertising which promotes visits to a seller's web site must rely on the prospective customers to engage in one or more volitional acts to move from a first advertising medium to a seller's web site, such as reading the seller's web address on the first advertising medium, turning on their computer terminal, contacting their Internet service provider, and typing the seller's web address into their Internet browser. Viewers of the first advertisement may lose interest and may not take the steps required to access the seller's web site. For example, they may not wish to turn on their computer terminals, contact their Internet service providers, and enter the web site address into their browser in order to access the seller's web site. Thus, to avoid the loss of the viewer's interest, it is desirable to provide an automatic connection from a first advertising medium to the seller's Internet web site.

Accordingly, the invention herein provides an automatic and direct link from a first advertising medium to the seller's Internet web site by utilizing computer-readable, pre-recorded medium as the first advertising medium and providing an automatic and direct link from the pre-recorded medium to the seller's Internet web site.

### SUMMARY OF THE INVENTION

A combination marketing system for use in the retail and wholesale sales of goods and services is disclosed. The marketing system preferably involves the distribution of a computer-readable, pre-recorded medium such as a CD-ROM or diskette (hereinafter collectively referred to as “prerecorded medium”) to a prospective customer, which includes a product and/or seller-specific presentation feature, a data collection feature, a data transmission feature, and a link feature. By using the combination marketing system, the seller is able to capture the attention of customers through a presentation regarding the seller's business and/or the goods and services offered for sale, obtain data from the customer, transmit the customer data to the seller's customized online database for future use by the seller, and directly and automatically link the customer to the seller's web site using the default Internet service provider on the customer's computer terminal.

The presentation feature of the marketing system enables the seller to capture the customer's attention through a multimedia presentation about the seller and/or the goods and services offered for sale, which presentation is contained on the pre-recorded medium. The data collection feature of the marketing system enables the seller to obtain information from the customer which may be useful in the seller's marketing efforts. The data transmission feature enables the seller to transmit information provided by the customer to the seller's customized online database for the seller's future marketing efforts directed to the customer.

The advantage of the combination marketing system of the present invention is that it allows the seller to capture the attention of a customer through a presentation regarding the seller and/or the goods and services offered for sale, obtain information from the customer, and automatically and directly link the customer to the seller's web site. In particular, the link feature of the present invention enables the seller to direct the customer from the pre-recorded medium to the seller's web site without the need for the customer to engage in a volitional act to move from the pre-recorded medium to the seller's web site, thereby avoiding the loss of the customer's attention and the possibility of the customer's error in entering the seller's web site address in the customer's Internet browser.

The link feature of the present invention is seamless from the customer's perspective. After the consumer inserts the pre-recorded medium into the customer's computer, views a presentation, and provides the requested data, the customer is automatically and directly linked to the seller's web site. The software on the pre-recorded medium automatically activates a process which transports the customer to the seller's web site at the appropriate time. The consumer is not required to activate any software features in order to access the seller's web site. For example, after providing the requested data, the customer need not click on a computer mouse, depress the enter button on the customer's computer keyboard, or engage in any other volitional act in order to proceed from the pre-recorded medium to the seller's web site. After the customer views the conclusion of the presentation feature, the next material which appears on the customer's computer screen is the seller's web site.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a block diagram of a preferred embodiment of the marketing system of the invention;

FIG. 2 is a preferred embodiment of the pre-recorded medium which is utilized by customers to access the combination marketing system of the present invention;

FIGS. 3A and 3B are screen displays of a preferred embodiment of the presentation feature of the present invention;

FIG. 4 is a preferred embodiment of the opening window of the data collection feature of the present invention;

FIG. 5 is a preferred embodiment of the second window of the data collection feature of the present invention;

FIG. 6 is a preferred embodiment of the third window of the data collection feature of the present invention;

FIG. 7 is another preferred embodiment of the presentation feature of the present invention;

FIG. 8 is a preferred embodiment of the opening page of the seller's web site which is accessed via the link feature of the present invention; and

FIGS. 9A, 9B, and 9C are screen displays of a preferred embodiment of the seller's online database which enables the seller to utilize the data collected from the customer.

Like numerals refer to like parts throughout the several views of the drawings.

### DETAILED DESCRIPTION OF THE PREFERRED EMBODIMENTS

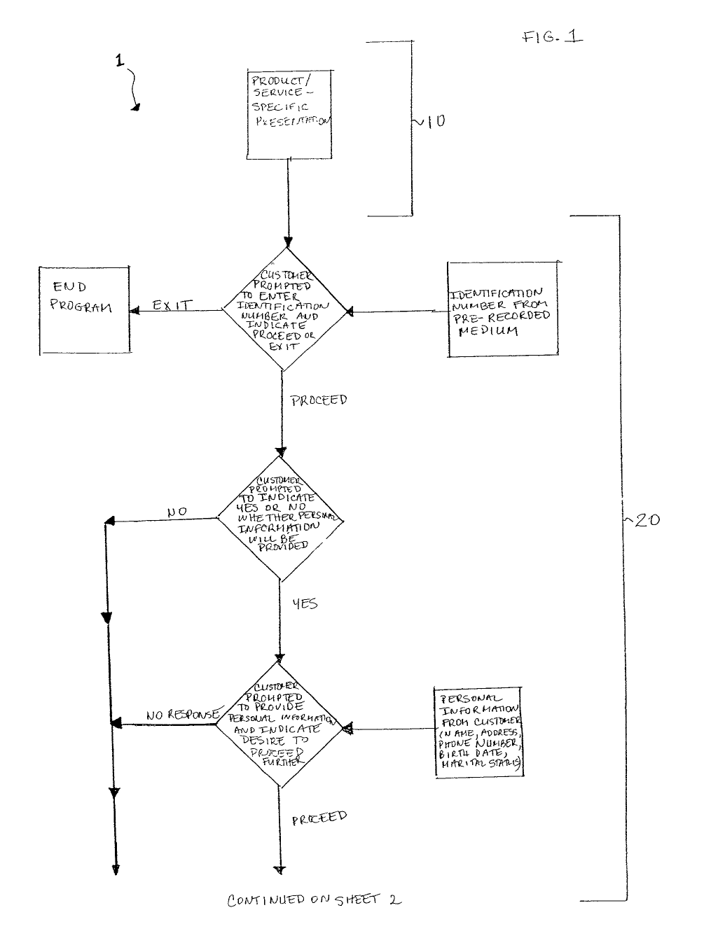

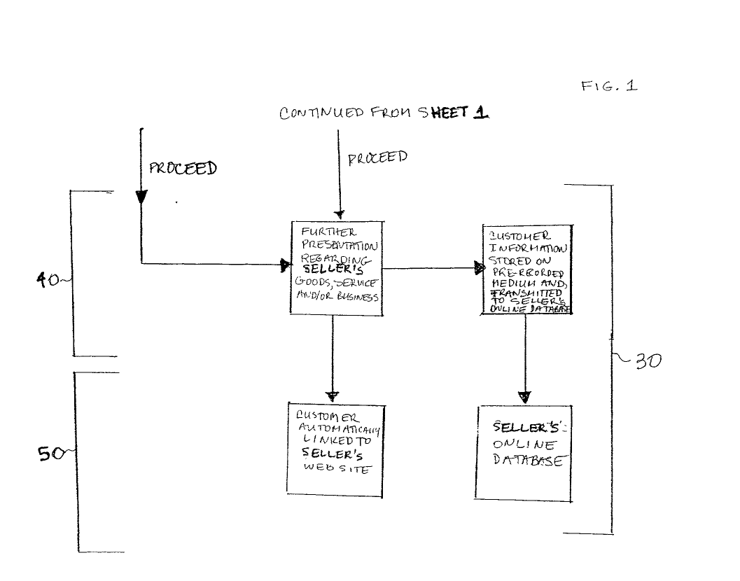

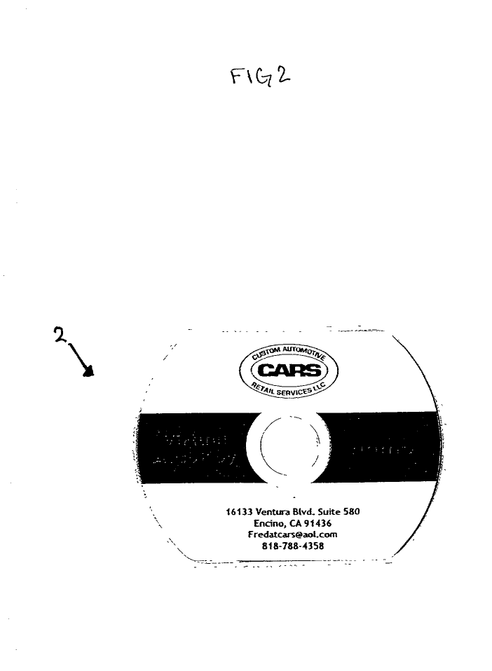

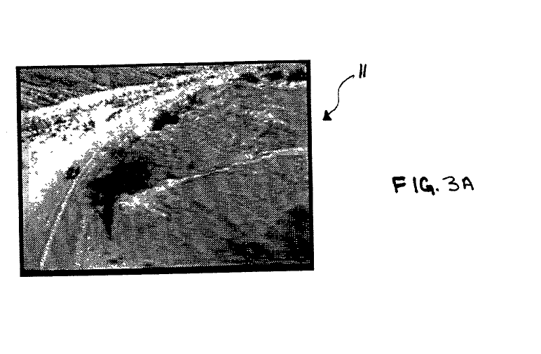

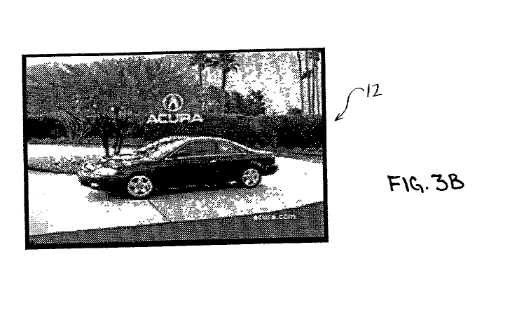

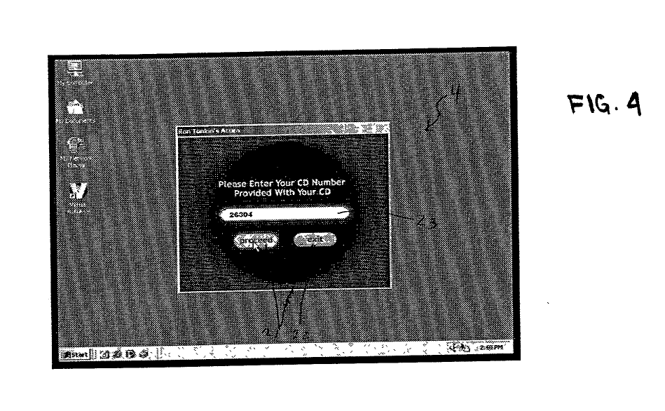

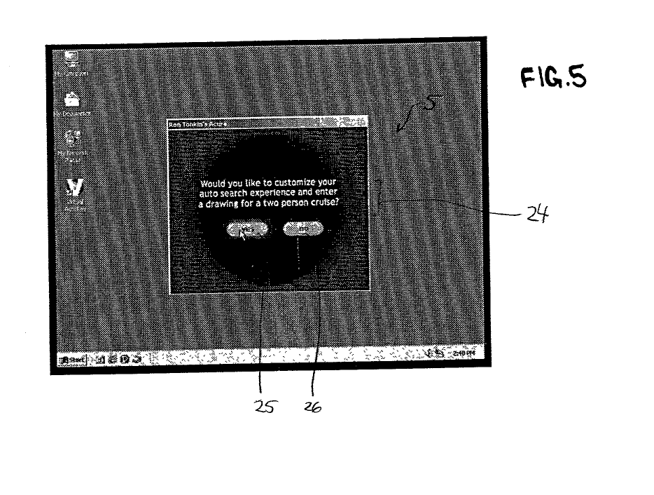

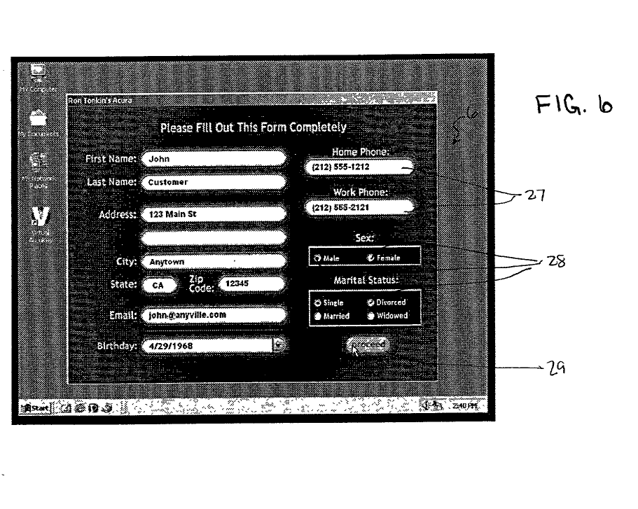

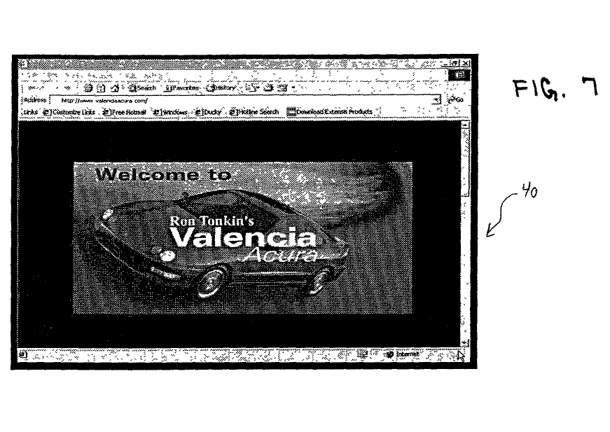

As best shown in FIG. 1, in a preferred embodiment of the present invention, the marketing system 1 for contacting a web site using a pre-recorded medium includes a presentation feature 10, 40, a data collection feature 20, a data transmission feature 30, and a link feature 50, as described more fully hereinafter.

In a preferred embodiment of the present invention, a combination marketing system is accessed via a pre-recorded medium 2 which is distributed by sellers to their customers.

The pre-recorded medium 2 is preferably a CD-ROM, as shown in FIG. 2, which CD-ROM is of a size and shape similar to that of a credit card. One of the benefits of using a credit-card shaped CD-ROM is that it can easily be retained customers' wallets or pockets for future viewing at the customer's convenience. The pre-recorded medium 2 may be inserted by a customer into a computer disk drive.

Upon insertion, the pre-recorded medium 2 automatically launches a presentation feature 10 as best depicted in FIG. 1. The presentation feature 10 enables the seller to capture the customer's interest and provide information to the customer regarding the seller's business and/or the seller's products and services. The presentation feature 10 preferably incorporates moving video images synchronized with an audio soundtrack, resulting in a multimedia presentation. FIGS. 3A and 3B depict screen displays 11, 12 of one embodiment of the presentation feature 10 of the present invention. The presentation depicted in FIGS. 3A and 3B is a multimedia presentation concerning an automobile.

Following the presentation feature 10, the opening window 4 of the data collection feature 20 is automatically displayed. As shown in FIG. 4, the opening window 4 of the data collection feature 20 preferably prompts the customer to enter a unique identification number which is prominently displayed on the face of the pre-recorded medium 2. The identification number enables the seller to track the customer's future use of the pre-recorded medium 2. The data collection feature 20 of the present invention enables the user to interactively respond to the queries posed by the system. In the embodiment shown in FIG. 4, the opening window 4 of the data collection feature 20 states, “Please enter your CD number provided with your CD” and provides an input box 23 in which the customer may enter this information. The opening window 4 of the data collection feature 20 preferably provides two navigational buttons 21, 22 below the input box 23, which are labeled “Proceed” and “Exit”, and which enable the customer to either proceed with the next steps in the marketing system or exit the system. The customer preferably may indicate his or her response by highlighting the desired navigation button 21, 22 and depressing the “Enter” button on the computer keyboard or by moving the computer mouse so that the pointing device is displayed over the desired navigational button 21,22 on the screen and then depressing the mouse button.

If the customer selects “Exit” 22 in response to the opening window 4 of the data collection feature 20, in a preferred embodiment of the present invention, the marketing system on the pre-recorded medium 2 terminates.

If the customer selects “Proceed” 21 in response to the opening window 4 of the data collection feature 20, in a preferred embodiment of the present invention, the second window 5 of the data collection feature 20 is automatically displayed. The second window 5 of the data collection feature 20 as shown in FIG. 5 preferably prompts the customer to indicate whether he or she is willing to provide the seller with the customer's personal information and enables the customer to indicate his or her response. In the embodiment shown in FIG. 5, the data collection feature 20 includes a message stating, in pertinent part, “Would you like to customize your auto search experience . . . ” In the embodiment shown in FIG. 5, the data collection feature 20 contains navigational buttons 25, 26 marked “Yes” and “No”, which enable the customer to indicate his or her response to the query 24 posed by the system. The customer preferably may indicate his or her response by highlighting the appropriate navigation button 25, 26 and depressing the “Enter” button on the computer keyboard or by moving the computer mouse so that the pointing device is displayed over the desired navigational button 25, 26 on the screen and then depressing the mouse button. The query 24 posed by the marketing system is preferably configured to elicit information pertaining to the identification or preferences of the user.

In a preferred embodiment of the invention, the data collection feature 20 enables the seller to provide an incentive to the customer for providing his or her personal information. For example, the seller may provide the customer with additional or upgraded goods and/or services if the customer is willing to provide his or her personal information. In the embodiment shown in FIG. 5, the second window 5 of the data collection feature 20 asks the customer, “Would you like to customize your auto search experience and enter a drawing for a two person cruise?”

If the customer selects “No” in response to the inquiry 24 in the second window 5 of the data collection feature 20, in a preferred embodiment of the present invention, the pre-recorded medium automatically launches a further presentation 40 regarding the seller's goods, services, and/or business.

If the customer selects “Yes” 25 in response to the inquiry 24 in the second window 5 of the data collection feature 20, in a preferred embodiment of the present invention, the third window 6 of the data collection feature 20 is automatically displayed. As shown in FIG. 6, the third window 6 of the data collection feature 20 preferably prompts the customer to provide one or more categories of personal information, enables the customer to provide the requested information, and enables the customer to indicate whether he or she wishes to proceed further. In the embodiment shown in FIG. 6, the third window 6 of the data collection feature 20 states, “Please fill out this form completely.” In the embodiment shown in FIG. 6, the third window 6 prompts the user for the following categories of personal information: First Name, Last Name, Address, City, State, Zip Code, E-mail address, Birth Date, Home Phone Number, Work Phone Number, Sex, and Marital Status. The third window 6 preferably includes input boxes 27 in which the customer may provide his or her First Name, Last Name, Address, City, State, Zip Code, E-mail address, Home Phone Number, Work Phone Number. In a preferred embodiment, a pull-down calendar feature (not shown) is available to assist the customer in providing his or her Birth Date and buttons 28 are preferably available to assist the customer in indicating his or her sex as “Male” or “Female” and his or her marital status as “Married”, “Single”, “Divorced”, or “Widowed”. The third window 6 of the data collection feature 20 preferably contains a navigational button 29, marked “Proceed”, which enables the customer to indicate his or her desire to proceed further. The customer preferably may indicate his or her response by highlighting the navigation button and depressing the “Enter” button on the computer keyboard or by moving the computer mouse so that the pointing device is displayed over the navigational button 29 on the screen and then depressing the mouse button.

If the customer does not indicate a desire to “Proceed” 29 in response to the third window 6 of the data collection feature 20, in a preferred embodiment of the present invention, the pre-recorded medium automatically launches a further presentation 40 regarding the seller's goods, services, and/or business.

In a preferred embodiment of the invention, the marketing system includes a data transmission feature 30, the operation of which is depicted in the block diagram of FIG. 1. Upon inputting data and/or personal information in response to the prompts in the data collection feature 20, the data transmission feature 30 immediately stores such data and/or information in the random access memory (“RAM”) of the customer's computer. The data and/or information remains in the RAM of the customer's computer until the link feature 40 is activated, as will be discussed in further detail below. Upon activation of the link feature 40, the customer is connected to the seller's web site and the data and/or information is transmitted to the seller's on-line database.

If the customer elects to proceed after providing data and/or personal information in response to the prompts in the data collection feature 20, in a preferred embodiment of the invention, the pre-recorded medium 2 immediately launches a further presentation feature 40. The further presentation feature 40 may feature the seller's goods and/or services and may enable the seller to provide the customer with information concerning the seller's business. For example, the presentation feature 40 may include the seller's name, address, hours of operation, driving directions, and information about the goods and/or services offered by the seller. The presentation feature 40 preferably incorporates moving video images synchronized with an audio soundtrack, resulting in a multimedia presentation. The presentation feature 40, as depicted in FIG. 7, is a multimedia presentation of a specific automobile dealer.

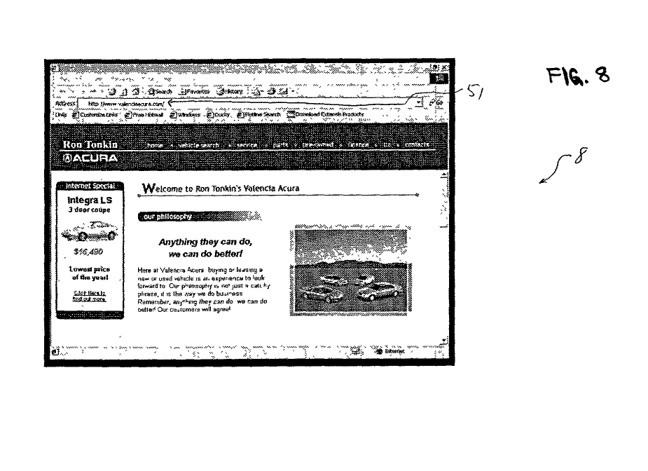

In a preferred embodiment of the invention, the marketing system includes a link feature 50 that provides an automatic link from the pre-recorded medium 2 to the seller's web site 8, shown in FIG. 8. The link feature 50 of the present invention preferably utilizes software on the pre-recorded medium 2 to provide the seller's web site address 51 and activate the dial up networking software on the customer's computer. The networking software preferably contacts the customer's default Internet service provider and loads the Internet browser software on the customer's computer, whereupon the browser software contacts the seller's web site 8 utilizing the seller's web site address 51 provided via the pre-recorded medium 2. In a preferred embodiment of the invention, the link feature 50 results in a transition from the presentation feature 40 to the seller's web site 8, which transition is seamless to the customer. The software on the prerecorded medium 2 automatically activates the link feature 50 and transports the customer to the seller's web site 8 at the appropriate time, and the consumer is not required to activate any software features or engage in any volitional acts in order to proceed from the final portion of the presentation feature 40 to the seller's web site 8.

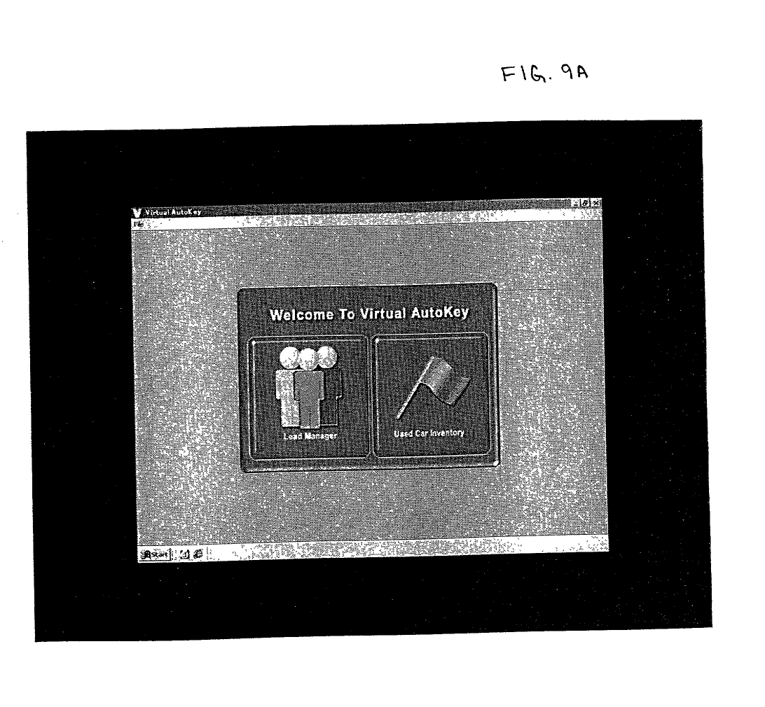

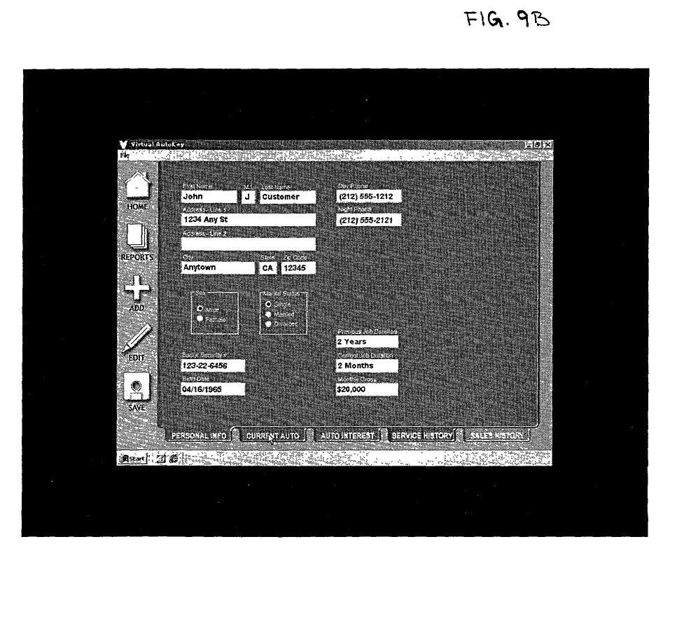

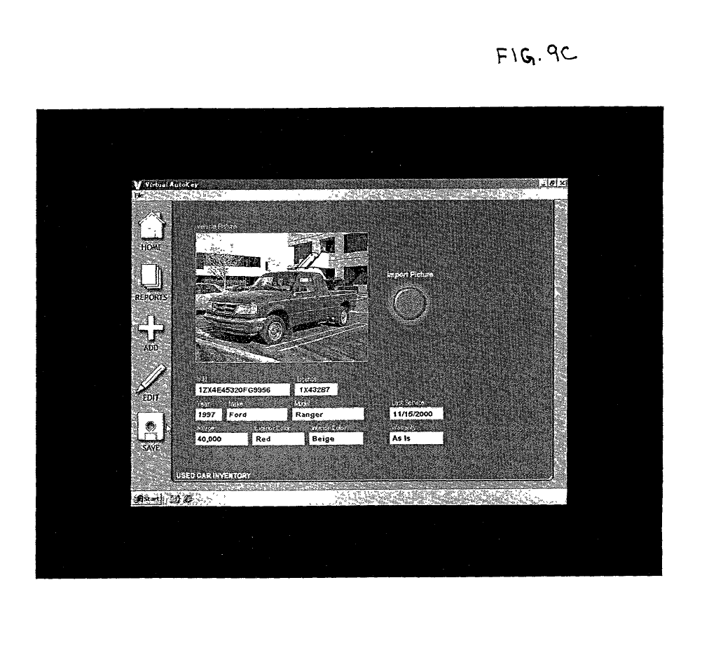

Upon the customer's connection to the seller's web site 8 via the link feature 50, the data transmission feature 30 automatically transmits the data and/or information received from the customer, which has been stored in the random access memory (“RAM”) on the customer's computer, to the seller's on-line database 9 (shown in FIG. 9) for use by the seller in marketing goods and services to the customer.

The embodiments described above are exemplary embodiments of the marketing system of the present invention. Those skilled in the art may now make numerous uses of, and departures from, the above-described embodiments without departing from the inventive concepts disclosed herein. For example, such departures could include alterations of the visual presentation of the graphical interfaces, the scope and extent of the information provided in each feature, and the organization of the functional features of the invention to provide accessibility to the features from various fields of the invention. The words “second” and “third” are used for reference purposes only and it is not intended to limit the order in which the windows are displayed nor is it intended to exclude the addition of other windows before, after, or between the windows described herein. Accordingly, the present invention is to be defined solely by the scope of the following claims.

What is claimed is:

1. A marketing system for use in advertising retail or wholesale sales of products or services comprising:
a terminal having a video display, which terminal can communicate with a global computer network, can access the seller's web site, and can receive and play a pre-recorded medium; and
a pre-recorded medium which upon insertion into the terminal will display the pre-recorded material and access and display the seller's web site.

2. A computer program product comprising a computer usable medium having computer readable program code embodied in said medium for effecting an automatic link to a web site.

3. A marketing system for use with a computer to direct a user to a marketed web site, the marketing system comprising a pre-recorded medium which upon activation automatically contacts the marketed web site.

4. A marketing system for advertising a seller's products or services on a video monitor connected to a computer terminal having access to a global computer network comprising:
pre-recorded medium playable on the video monitor;
means in the pre-recorded medium for automatically launching a presentation concerning goods and services offered for sale by a seller; and
means in the pre-recorded medium for accessing and displaying the seller's web site on the video monitor.

5. A marketing process for advertising a seller's products or services utilizing a computer terminal activated pre-recorded medium and a computer terminal and video monitor having access to a seller's web site on a global computer network, comprising the steps of: p1 (a) receiving the pre-recorded medium by a prospective customer of the seller;
(b) playing the pre-recorded medium on the video monitor;
(c) automatically linking to the seller's web site; and
(d) accessing and displaying the seller's web site.

6. A marketing system for advertising a seller's products or services comprising a computer terminal having a video display, which terminal can communicate with a global computer network, can access the seller's web site, and can play a pre-recorded medium, and pre-recorded medium containing:
a presentation feature wherein, upon insertion into the computer terminal, the pre-recorded medium automatically launches a presentation concerning goods and/or services offered for sale by a seller;
a data collection feature, wherein the pre-recorded medium displays a series of windows and messages which prompt the customer to enter data and/or personal information which will assist the seller in marketing goods and services to the customer;
a data transmission feature, wherein the pre-recorded medium immediately stores the data and/or information provided by the customer in the random access memory (“RAM”) on the customer's computer and subsequently transmits the data and/or information to the seller's online database upon the customer's connection to the seller's web site; and
a link feature, wherein, upon the conclusion of the presentation material on the pre-recorded medium, the software on the pre-recorded medium provides the customer's computer with the seller's Internet web site address and initiates an automatic process which activates the dial up networking software on the customer's computer, the customer's default Internet service provider, and the Internet browser software on the customer's computer, whereupon the customer is transported to the seller's web site in a manner which is seamless from the customer's perspective and which requires no volitional act by the customer in order to move from the conclusion of the presentation feature to the seller's web site.

7. A system of providing information to a user, comprising a computer operated, pre-recorded medium having a user data capture to record information provided by the user and a presentation repository in communication with a web site wherein upon activation, the presentation repository automatically contacts the web site.
